(19) United States
(12) Patent Application Publication
(10) Pub. No.: US 2022/0053588 A1
(43) Pub. Date: Feb. 17, 2022

(54) SYSTEMS, DEVICES, AND METHODS FOR CONNECTION REESTABLISHMENT VIA ALTERNATIVE ROUTES IN INTEGRATED ACCESS AND BACKHAUL DUE TO RADIO LINK FAILURES

(71) Applicants: SHARP KABUSHIKI KAISHA, Sakai City, Osaka (JP); FG INNOVATION COMPANY LIMITED, Tuen Mun, New Territories (HK)

(72) Inventors: Kamel M. SHAHEEN, Vancouver, WA (US); JOHN KOWALSKI, Vancouver, WA (US); JIA SHENG, Vancouver, WA (US); TATSUSHI AIBA, Sakai City, Osaka (JP)

(21) Appl. No.: 17/276,078

(22) PCT Filed: Sep. 2, 2019
(86) PCT No.: PCT/JP2019/034403

§ 371 Date: Mar. 12, 2021

Related U.S. Application Data
(60) Provisional application No. 62/734,972, filed on Sep. 21, 2018.

(51) Int. Cl. H04W 76/19; H04W 40/24; H04W 36/00

(52) U.S. Cl. CPC H04W 76/19; H04W 36/0055; H04W 40/248

(57) ABSTRACT

A method of reestablishing a connection based on a Radio Link Failure (RLF) in a Wireless Relay Network using alternative routes, the wireless relay network having a donor node, a first node (IAB-node A), a second node (IAB-node B), a third node (IAB-node X), and a fourth node (IAB-node C), wherein the donor node is an Integrated Access and Backhaul (IAB) node connected to a core network, and wherein the first node, the second node, the third node, and the fourth node each have Mobile Termination (MT) functionality capabilities.

### CROSS REFERENCE

This Nonprovisional application claims priority under 35 U.S.C. § 119 on provisional Application No. 62/734,972 on Sep. 21, 2018, the entire contents of which are hereby incorporated by reference.

### TECHNICAL FIELD

The present embodiments relate to Integrated Access and Backhaul and backhauling for New Radio (NR) networks having Next generation NodeB capabilities and signaling. In particular, the present embodiments relate to a backhaul infrastructure and design for User Equipment and relay networks to reestablish connections between nodes in response to Radio Link Failures in the network by using alternative routes and maintain an end to end connection.

### BACKGROUND ART

In typical cellular mobile communication systems and networks, such as Long-Term Evolution (LTE) and New Radio (NR), a service area is covered by one or more base stations, where each of such base stations may be connected to a core network by fixed-line backhaul links (e.g., optical fiber cables). In some instances, due to weak signals from the base station at the edge of the service area, users tend to experience performance issues, such as: reduced data rates, high probability of link failures, etc. A relay node concept has been introduced to expand the coverage area and increase the signal quality. As implemented, the relay node may be connected to the base station using a wireless backhaul link.

In 3^{rd} Generation Partnership Project (3GPP), the relay node concept for the fifth generation (5G) cellular system has been discussed and standardized, where the relay nodes may utilize the same 5G radio access technologies (New Radio (NR)) for the operation of services to User Equipment (UE) (access link) and connections to the core network (backhaul link) simultaneously. These radio links may be multiplexed in time, frequency, and/or space. This system may be referred to as Integrated Access and Backhaul (IAB).

Some such cellular mobile communication systems and networks may comprise

IAB-donors and IAB-nodes, where an IAB-donor may provide interface to a core network by UEs and wireless backhauling functionality to IAB-nodes; and additionally, an IAB-node may provide IAB functionality combined with wireless self-backhauling capabilities. IAB-nodes may need to periodically perform inter-IAB-node discovery to detect new IAB-nodes in their vicinity based on cell-specific reference signals (e.g., Single-Sideband SSB). The cell-specific reference signals may be broadcasted on a Physical Broadcast Channel (PBCH) where packets may be carried or broadcasted on the Master Information Block° (MIB) section.

Demand for wireless traffic has increased significantly over time and IAB systems are expected to be reliable and robust against various possible types of failures. Considerations have been given for IAB backhaul design. In particular, to provide methods and procedures to address radio link failures on the backhaul link by detecting the failure and reestablishing severed connections with the IAB-donor through alternative routes.

### SUMMARY OF INVENTION

In one example, a method of reestablishing a connection based on a Radio Link Failure (RLF) in a Wireless Relay Network using alternative routes, the wireless relay network having a donor node, a first node (IAB-node A), a second node (IAB-node B), a third node (IAB-node X), and a fourth node (IAB-node C), wherein the donor node is an Integrated Access and Backhaul (IAB) node connected to a core network, and wherein the first node, the second node, the third node, and the fourth node each have Mobile Termination (MT) functionality capabilities, the method comprising: detecting, by the second node, an RLF with the fourth node, based on a received notification to indicate a radio link failure; selecting, by the second node, the third node based on the third node being a suitable node from a list, wherein the list comprises Integrated Access and Backhaul (IAB) capable nodes which were configured by the donor node during a previously performed IAB setup procedure; performing, by the second node, a cell reselection procedure with the third node, wherein the reselection procedure includes messaging indicating the occurrence of the RLF between the second node and the fourth node; establishing, by the second node, a connection to the donor node via the cell reselection to the third node; transmitting, by the second node to the donor node, messages comprising the RLF, nodes involved, and affected Data Radio Bearers of the associated nodes; transmitting, by the donor node to the second node, a response with new configuration regarding a next hop node, wherein the second node waits for a period of time for the response; reconstructing, by the second node, a new local routing table comprising a reselected next hop cell based on the received response with the new configuration from the donor node; and reestablishing, by the second node, the Data Radio Bearers of the associated nodes with the donor node.

In one example, a wireless node equipped with at least two radio interfaces comprising a first interface and a second interface, the first interface being configured to establish a first radio link with at least one parent node, the second interface being configured to establish a second radio link(s) with one or more wireless terminals, the wireless node having a processor circuitry and addressable memory, the processor configured to: detect a Radio Link Failure (RLF) with another node based on a received notification to indicate a radio link failure (dep: connected mode); select a new node to establish a radio link with based on the new node being a suitable node from a list, wherein the list comprises Integrated Access and Backhaul (IAB) capable nodes which were configured by a donor node during a previously performed IAB setup procedure; perform a cell reselection procedure with the new node, wherein the reselection procedure includes messaging indicating the occurrence of the RLF; establish a connection to the donor node via the cell reselection to the new node; transmit messages to the donor node, the messages comprising the RLF, nodes involved, and affected Data Radio Bearers of the associated nodes; wait to receive from the donor node a response with new configuration regarding a next hop node; re-construct a new local routing table comprising a reselected next hop cell based on the received response with the new configuration from the donor node; and reestablish the Data Radio Bearers of the associated nodes with the donor node.

### BRIEF DESCRIPTION OF DRAWINGS

The various embodiments of the present embodiments now will be discussed in detail with an emphasis on highlighting the advantageous features. These embodiments depict the novel and non-obvious aspects of the invention shown in the accompanying drawings, which are for illustrative purposes only. These drawings include the following figures, in which like numerals indicate like parts.

FIG. 1 illustrates a mobile network infrastructure using 5G signals and 5G base stations.

FIG. 2 depicts in further details the IAB-donor of FIG. 1 and additional nodes present in an example of a mobile network.

FIG. 3A illustrates different architecture having protocols IAB-nodes and IAB-donor along with Control Plane (C-Plane) and User Plane (U-Plane) protocols.

FIG. 3B illustrates different architecture having protocols IAB-nodes and IAB-donor along with Control Plane (C-Plane) and User Plane (U-Plane) protocols.

FIG. 3C illustrates different architecture having protocols IAB-nodes and IAB-donor along with Control Plane (C-Plane) and User Plane (U-Plane) protocols.

FIG. 3D illustrates different architecture having protocols IAB-nodes and IAB-donor along with Control Plane (C-Plane) and User Plane (U-Plane) protocols.

FIG. 3E illustrates different architecture having protocols IAB-nodes and IAB-donor along with Control Plane (C-Plane) and User Plane (U-Plane) protocols.

FIG. 4A depicts example of a mapping between a UE Data Radio Bearer (DRB) and Backhaul (BH) Radio Link Control Channel.

FIG. 4B depicts example of a mapping between a UE Data Radio Bearer (DRB) and Backhaul (BH) Radio Link Control Channel.

FIG. 5 depicts a Radio Link Failure in a mobile network between two IAB-nodes.

FIG. 6 depicts an example message sequence for processing by IAB-node(s) and an IAB-donor.

FIG. 7 is a flowchart depicting an exemplary process for reestablishing a connection via alternative routes in an IAB.

FIG. 8A depicts an example message sequence for processing by IAB-node(s) and an IAB-donor.

FIG. 8B depicts another example message sequence for processing by IAB-node(s) and an IAB-donor

FIG. 9 is a flowchart depicting an exemplary process for reestablishing a connection via alternative routes in an IAB.

FIG. 10 is a diagram illustrating an example of a radio protocol architecture for the control and user planes in a mobile communications network.

FIG. 11 illustrates an example of a set of components of a user equipment or base station.

FIG. 12 illustrates a mobile network infrastructure where a number of UEs are connected to a set of IAB-nodes and the IAB-nodes are in communication with an IAB-donor.

FIG. 13 illustrates an example top level functional block diagram of a computing device embodiment.

FIG. 14 is a flowchart depicting an exemplary process for reestablishing a connection via alternative routes in an IAB.

FIG. 15A is a functional block diagram of a wireless node device which may be a parent IAB-node that may be in communication with an IAB-donor upstream and a UE and/or child IAB-node downstream.

FIG. 15B is a functional block diagram of a wireless terminal device which may be an IAB-node in communication with an IAB-donor or a parent IAB-node upstream.

### DESCRIPTION OF EMBODIMENTS

The various embodiments of the present Systems, Devices, and Methods for

Connection Reestablishment via Alternative Routes in Integrated Access and Backhaul due to Radio Link Failures have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

Embodiments disclosed provide methods and systems for handling a scenario where an Integrated Access and Backhaul (TAB) node, for example, an IAB-parent node and/or an TAB-child node, loses the connection to another IAB-node due to a radio link failure. The disclosed embodiments provide a method for the IAB-node (e.g., IAB-child or IAB-parent) to detect such link failures and inform an TAB-donor to reestablish connections for UEs and/or IAB-nodes in order to allow them to continue end to end connection for Data Radio Bearers (DRBs) to carry user plane data. The IAB-nodes may, based on the upstream or downstream communication link, continue to stay connected with the TAB-donor by having to reestablish a link with another cell/IAB-node. That is, via the IAB-node that is serving the child nodes and/or UEs, performing an RRC reestablishment with a new IAB-node (e.g., parent to the serving IAB-node) the TAB-donor may determine and reconfigure a new route. Thereby, the IAB-node serving the child nodes and/or UEs may perform a reselection to another cell/TAB node in order to reestablish a connection with the TAB-donor. In some embodiments, the information representing the radio condition of the upstream or downstream links of the TAB node may be based on signal strength, for example, Reference Signal Received Power (RSRP)/Reference Signal Received Quality (RSRQ) levels, and an associated threshold, which a UE may use to determine whether to camp on the cell (TAB-donor or IAB-node).

The various embodiments of the present Systems, Devices, and Methods for

Connection Reestablishment via Alternative Routes in Integrated Access and Backhaul due to Radio Link Failures now will be discussed in detail with an emphasis on high-lighting the advantageous features. Additionally, the following detailed description describes the present embodiments with reference to the drawings.

A mobile network used in wireless networks may be where the source and destination are interconnected by way of a plurality of nodes. In such a network, the source and destination may not be able to communicate with each other directly due to the distance between the source and destination being greater than the transmission range of the nodes. That is, a need exists for intermediate node(s) to relay communications and provide transmission of information. Accordingly, intermediate node(s) may be used to relay information signals in a relay network, having a network topology where the source and destination are interconnected by means of such intermediate nodes. In a hierarchical telecommunications network, the backhaul portion of the network may comprise the intermediate links between the core network and the small subnetworks of the entire hierarchical network. Integrated Access and Backhaul (TAB) Next generation NodeB use 5G New Radio communications such as transmitting and receiving NR User Plane (U-Plane) data traffic and NR Control Plane (C-Plane) data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Radio Link Control (RLC) Protocol.

In some aspects of the embodiments for reestablishment of links through alternative routes in Integrated Access and Backhaul due to radio link failures, new and/or existing Information Elements (IEs) may be used in Radio Resource Control (RRC) messages to communicate RLF conditions. Accordingly, in one embodiment, an Adaptation layer may extract the IEs from the RRC message in order to determine an alternative IAB node to connect to, or route toward, an IAB-donor node. Additional IEs may also be used in the F-interface messages to identify different conditions. Embodiments disclosed provide such communication with the Central Unit (CU) of the IAB-donor.

Embodiments of the present system disclose methods and devices for an IAB-node to detect downstream and/or upstream radio conditions and accordingly, the term IAB-node may be used to represent either a parent IAB-node or a child IAB-node, depending on where the IAB-node is in the network communication with the IAB-donor which is responsible for the physical connection with the core network. Embodiments are disclosed where an IAB-node (child or parent IAB-node) may follow the same initial access procedure as a UE, including cell search, system information acquisition, and random access, in order to initially set up a connection to a parent IAB-node or an IAB-donor. That is, when an IAB-node needs to establish a backhaul connection to, or camp on, a parent IAB-node or an IAB-donor, the IAB-node may perform the same procedures and steps as a UE, where the IAB-node may be treated as a UE but distinguished from a UE by the parent IAB-node or the IAB-donor.

In the disclosed embodiments for handling radio link failures in wireless relay networks, MT functionality typically offered by a UE may be implemented on an IAB-node. In some examples of the disclosed systems, methods, and device embodiments, consideration may be made in order for a child IAB-node to monitor upstream radio conditions on a parent IAB-node where the parent IAB-node may itself be a child IAB-node in communication with an IAB-donor and for a parent IAB-node to monitor downstream radio conditions on a child IAB-node.

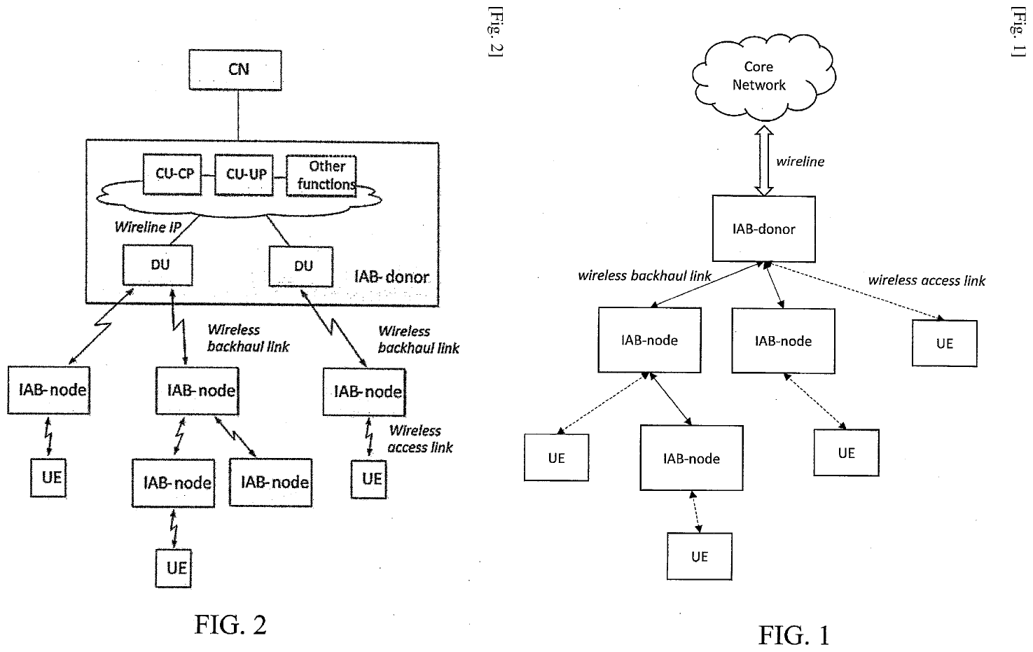

With reference to FIG. 1, the present embodiments include a mobile network infrastructure using 5G signals and 5G base stations (or cell stations). Depicted is a system diagram of a radio access network utilizing IAB nodes, where the radio access network may comprise, for example, one IAB-donor and multiple IAB-nodes. Different embodiments may comprise different number of IAB-donor and IAB-node ratios. Herein, the IAB nodes may also be referred to as IAB relay nodes. The IAB-node may be a Radio Access Network (RAN) node that supports wireless access to UEs and wirelessly backhauls the access traffic. The IAB-donor is a RAN node which may provide an interface to the core network to UEs and wireless backhauling functionality to IAB nodes. An IAB-node and/or IAB-donor may serve one or more IAB nodes using wireless backhaul links as well as UEs using wireless access links, simultaneously. Accordingly, network backhaul traffic conditions may be implemented based on the wireless communication system to a plurality of IAB nodes and UEs.

With further reference to FIG. 1, a number of UEs are depicted as in communication with IAB nodes, for example, IAB-nodes and IAB-donor node, via wireless access link. Additionally, the IAB-nodes (child nodes) may be in communication with other IAB-nodes and/or an IAB-donor (all of which may be considered IAB parent nodes) via wireless backhaul link. For example, a UE may be connected to an IAB-node which itself may be connected to a parent IAB-node in communication with an IAB-donor, thereby extending the backhaul resources to allow for the transmission of backhaul traffic within the network and between parent and child for integrated access. The embodiments of the system provide for capabilities needed to use the broadcast channel for carrying information bit(s) (on the physical channels) and provide access to the core network.

FIG. 2 depicts in further details the IAB-donor of FIG. 1 and additional nodes present in an example of a mobile network. The IAB-donor may comprise at least one Central Unit (CU) and at least one Distributed Unit (DU). The CU is a logical entity managing the DU collocated in the IAB-donor as well as the remote DUs resident in the IAB-nodes. The CU may also be an interface to the core network, behaving as a RAN base station (e.g., eNB or gNB). In one embodiment, the CU may provide multiple functions, for example, Control Plane functionality or User Plane functionality, etc. In some embodiments, the DU is a logical entity hosting a radio interface (backhaul/access) for other IAB-nodes and/or UEs. In one configuration, under the control of CU, the DU may offer a physical layer and Layer-2 (L2) protocols (e.g., Medium Access Control (MAC), Radio Link Control (RLC), etc.) while the CU may manage upper layer protocols (such as Packet Data Convergence Protocol (PDCP), Radio Resource Control (RRC), etc.).

Embodiments include a Standalone (SA mode) mobile network infrastructure where a number of UEs are connected to a set of IAB-nodes and the IAB-nodes are in communication with other IAB-nodes as part of a relay network to provide an end to end communication with the IAB-donor using the different aspects of the present embodiments. In some embodiments, the UEs and/or IAB-nodes may communicate with the CU of the IAB-donor on the Control Plane (C-Plane) using RRC protocol and in other embodiments, using Service Data Adaptation Protocol (SDAP) and/or Packet Data Convergence Protocol (PDCP) radio protocol architecture for data transport (User Plane (U-Plane)) through NR gNB. In some embodiments, the DU of the IAB-node may communicate with the CU of the IAB-donor using 5G radio network layer signaling protocol: F1 Application Protocol (F1-AP*) which is a wireless backhaul protocol that provides signaling services between the DU of an IAB-node and the CU of an IAB-donor. That is, as further described below, the protocol stack configuration may be interchangeable, and different mechanism may be used.

Currently, 3GPP RAN2 (TR38.874) is discussing ways to support Integrated Access and Backhaul (IAB) including architectures, radio protocols, and physical layer aspects related to relaying of access traffic by sharing radio resources between access and backhaul links. A key benefit of IAB is enabling flexible and very dense deployment of NR cells without densifying the transport network proportionately. A diverse range of deployment scenarios can be envisioned including support for outdoor small cell deployments, indoors, or even mobile relays (e.g., on buses or trains).

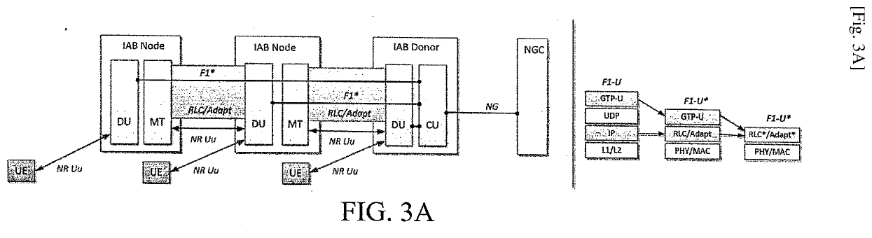

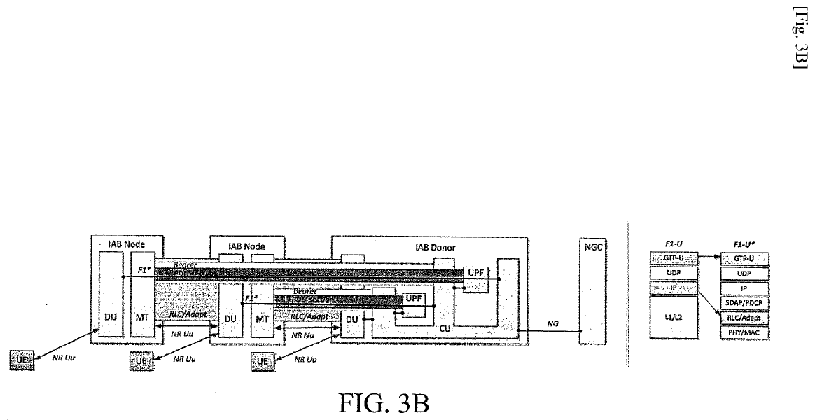

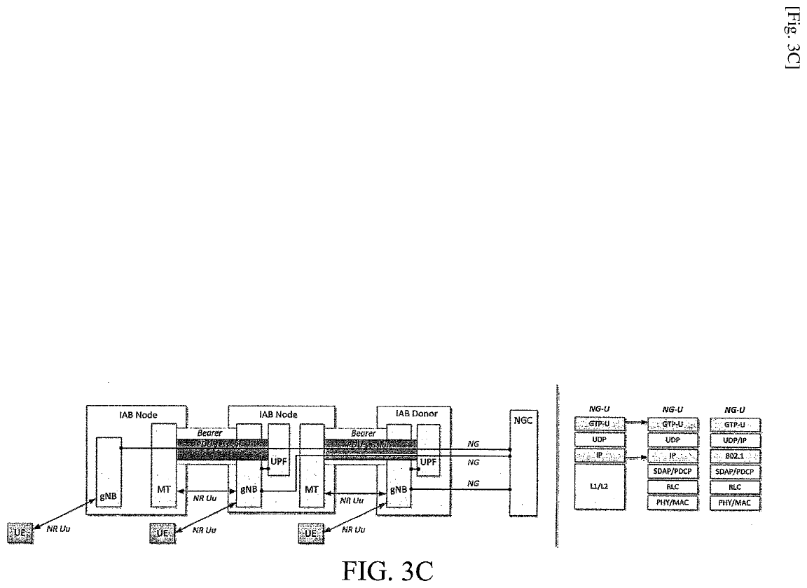

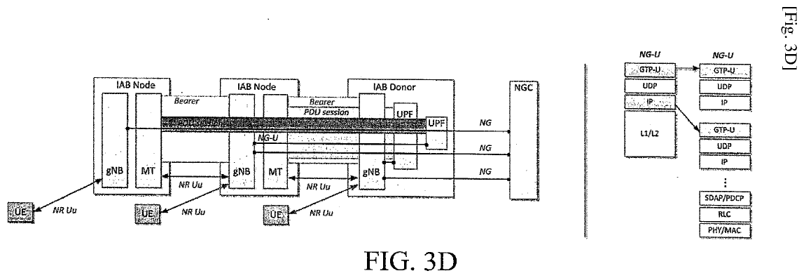

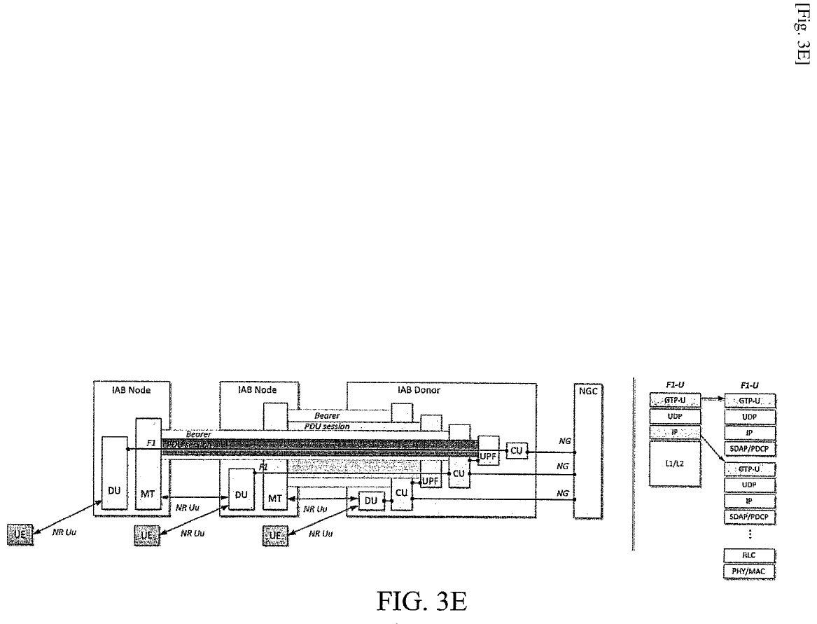

As illustrated by the diagrams shown in FIGS. 3A-3E, different architectures having protocols for Next Generation Core (NGC) among the IAB-nodes and IAB donor is shown. Some such protocols may be grouped into Control Plane (C-Plane) and User Plane (U-Plane) where C-Plane carries control signals (signaling data), whereas the U-Plane carries user data.

In one embodiment, an Adaptation Layer is introduced between the IAB-node and the IAB-node/donor, where the Adaptation Layer carries relay-specific information, such as IAB-node/donor addresses, QoS information, UE identifiers, and potentially other information. In this embodiment, RLC (3GPP TS 38.322) may provide reliable transmission in a hop-by-hop manner while PDCP may perform end-to-end (UE-CU) error recovery. GTP-U (GPRS Tunneling Protocol User Plane) may be used for routing user data between CU and DU inside the IAB-donor.

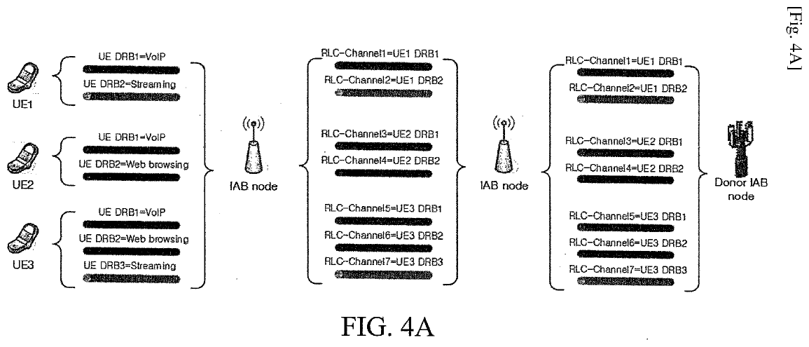

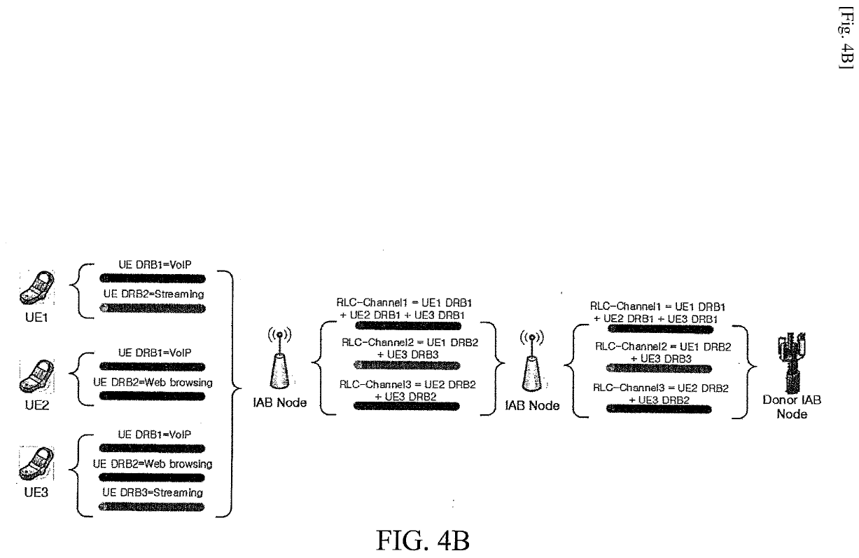

FIG. 4A illustrates an example of a one to one mapping between a UE Data Radio

Bearer (DRB) and Backhaul (BH) Radio Link Control Channel. That is, the UE's DRB and IAB's backhaul RLC-Channel are shown as mapped using the different architectures. FIG. 4B illustrates an example of a per QoS mapping between UE DRB and BH RLC-Channel. The above architectures are provided by way of examples and not limitations.

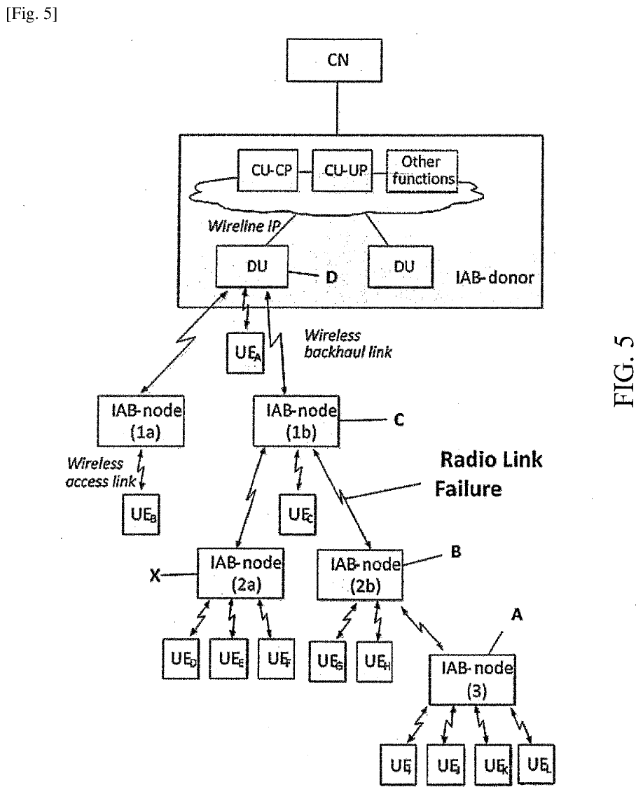

FIG. 5 is a functional block diagram of an example wireless environment where a Radio Link Failure (RLF) has occurred between two IAB-nodes in the network. In such wireless environment, RFLs need to be taken into consideration and supporting procedures implemented in order to ensure service continuity. Accordingly, the present embodiments provide a mechanism for the IAB-node (upstream and downstream) to detect an RLF. That is, IAB-nodes need to reestablish the connection to the Donor IAB Node as soon as possible, e.g., in as short a time as feasible if an RLF is detected. Currently, there are no such procedures to ensure the appropriate establishment of the recovery path with correct QoS mapping of the affected traffic (DRBs) according to the alternative architectures as shows in FIGS. 3A-3E and 4A-4B.

With further reference to FIG. 5, an RLF is shows in the IAB network having 3 hops and 12 UEs as part of the network. In one embodiment, since the link between an IAB-node (1b) and another IAB-node (2b) is broken, the downstream child nodes and/or UEs may experience a disruption of service if the link is not reestablished or a new link created and established. That is, in this example IAB-node (3) having UEᵢ, UEⱼ, UEₖ, UEₗ camped on it along with IAB-node (2b) with UE_{g} and UEₕ camped on it, may no longer be connected with the IAB-donor due to the RLF between IAB-node (1b) and IAB-node (2b).

In the disclosed embodiments, procedures are introduced to re-establish severed connections due to RLF and restore the connection to the donor Node with the correct bearers (DRBs), services, and QoS attributes, for example, via alternative routes. This is necessary for both the UEs in the network and IAB-nodes to maintain their connection with the IAB-donor.

Using existing definitions (as defined in Section 9.2.7 of 3GPP TS 38.300 V15.2.0 (2018-06)), when in RRC_CONNECTED mode, a UE may declare Radio Link Failure (RLF) when one of the following criteria are met:
Expiry of a timer started after indication of radio problems from the physical layer (if radio problems are recovered before the timer is expired, the UE stops the timer);
Random access procedure failure;

After RLF is declared, the UE may:
stay in RRC_CONNECTED;
select a suitable cell and then initiates RRC re-establishment;
enter RRC_IDLE if a suitable cell wasn't found within a certain time after RLF was declared.

As the above covers a UE's procedures in response to a link failure, if a link failure occurs between IAB-nodes, the suitable cell has to be an IAB capable cell (Node) which needs to be configured and/or provisioned by the CU entity during the IAB setup procedures. The IAB-nodes may store, maintain, perform measure report on a separate list of IAB capable nodes (such as a local routing table) where alternative routing may be established in case of Radio Link Failure. Accordingly, the CU of the IAB-donor may maintain a list of all these information in a master Routing table of IAB nodes.

In the above scenarios, the MT component of either a UE or IAB-node may establish an RRC connection with the CU component of the IAB-donor. In parallel, RRC may be used for carrying another signaling protocol in order for CU/IAB-donor to control the DU component resident in the IAB-nodes. In one embodiment, such a signaling protocol may be referred to as Fl Application Protocol* (F1-AP*), a protocol based on F1-AP specified in 3GPP TS 38.473, with potential extended features to accommodate wireless backhauls (the original F1-AP is designed for wirelines). In other embodiments, F1-AP may be used for CU-DU connection inside the IAB-donor. It is assumed that below RLC, MAC/PHY layers are shared with the U-Plane. In some examples, the MT of each IAB-node or UE may have its own end-to-end RRC connection with the CU of the IAB-donor. Likewise, the DU of each IAB-node may have an end-to-end F1-AP* connection with the CU of the IAB-donor. Any IAB nodes present between such end points transparently convey RRC or F1-AP signaling traffic.

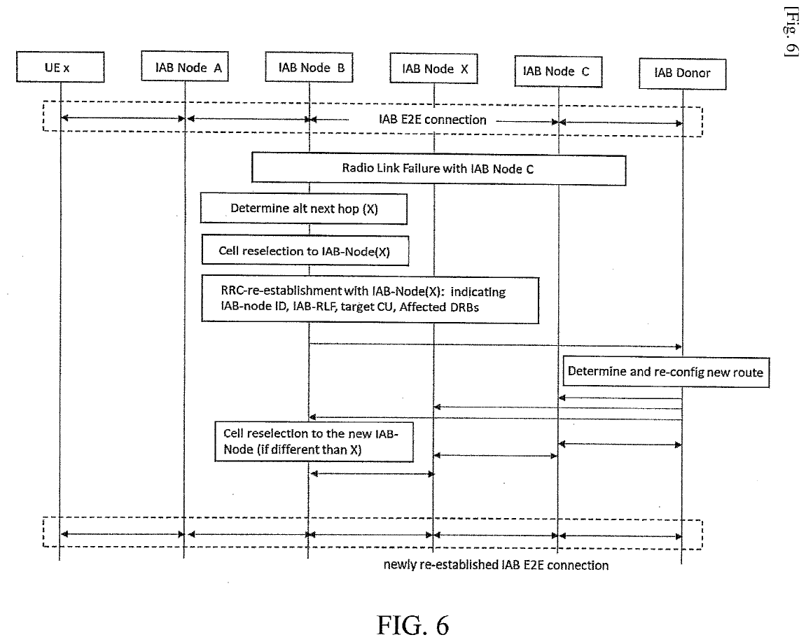

FIG. 6 is a diagram of an example flow of information transmit/receive and/or processing by IAB-node(s) and an IAB-donor according to aspects of the present embodiments. As depicted, a message sequence for IAB-node A, IAB-node B, IAB-node X, IAB-node C, and IAB-donor is used to establish an end to end connection between the IABs (IAB E2E connection) including UE x. With further reference to FIG. 6, a Radio Link Failure may have occurred between IAB-node B and IAB-node C, where IAB-node B has detected such failure (downstream detection). IAB-node B may then determine an alternative next hope (in this example, with IAB-node X), in response to the detected RLF with IAB-node C. In this embodiment, IAB-node B may execute a cell reselection to IAB-node X to establish an RRC connection, followed by F1-AP* connection. It is assumed that IAB-node B has been pre-configured (or configured by the network) with information that instructs how to select a cell served by the IAB-donor. As shown in the figure, IAB-node B may initiate an RRC connection reestablishment procedure with IAB-node X by indicating: IAB-node ID, IAB-RLF, target CU, and/or Affected DRBs. In one embodiment, a flag indicating an RLF has happened may also be transmitted along with the other information to the IAB-donor for updating the routing table. Based on this information being received by the IAB-donor, the IAB-donor may determine and reconfigure the new route. In an embodiment where the IAB-donor determines that IAB-node X is not the suitable cell for connection, a message is sent to IAB-node B to have IAB-node B initiate a cell reselection to a new IAB-node (different than IAB-node X). Once the reselection is completed, the newly reestablished IAB E2E connection is formed.

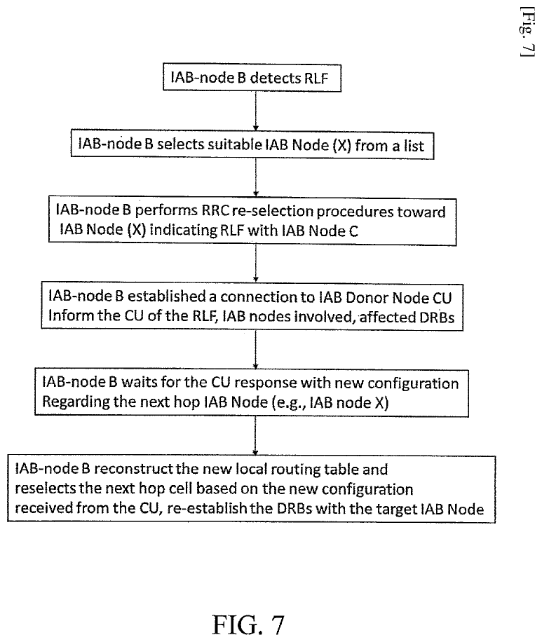

FIG. 7 is a flowchart of an exemplary process method of reestablishing connection with an IAB-donor after a Radio Link Failure (RLF) in a wireless network in which the system comprises the same nodes as depicted in FIG. 6. The method depicted in the flowchart includes the steps of: (a) IAB-node B detects RLF with IAB-node C (step 710); (b) IAB-node B selects a suitable IAB-node (IAB-node X) from a list (step 720); (c) IAB-node B performs RRC reselection procedures toward IAB-node X indicating RLF with IAB-node C (step 730); (d) IAB-node B establishes a connection to IAB-donor CU and informs the CU of the RLF, the IAB-nodes involved, and/or affected DRBs (step 740); (e) IAB-node B waits for the CU response with new configuration regarding the next hop IAB-node (for example, IAB-node X) (step 750); and (f) IAB-node B reconstructs the new local routing table and reselects the next hop based on the new configuration received from the CU, and reestablish the DRBs with the target IAB-node (IAB-donor) (step 760).

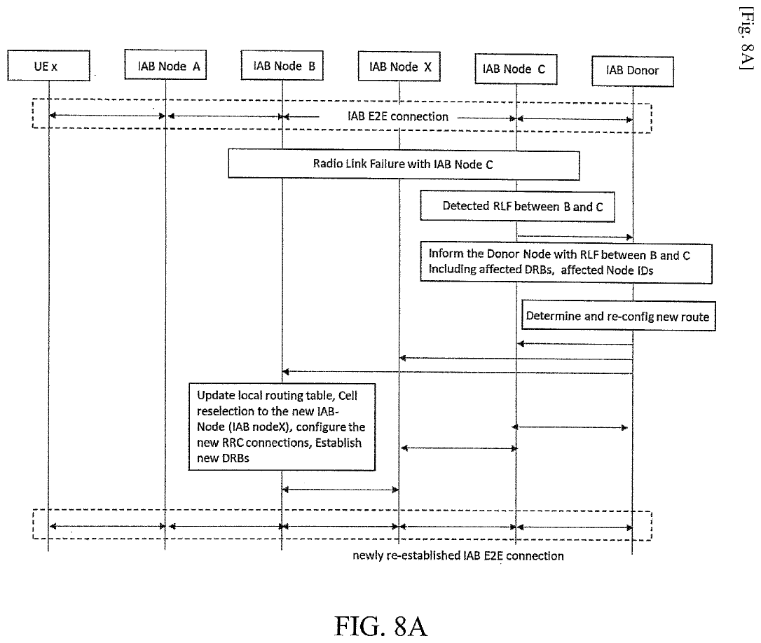

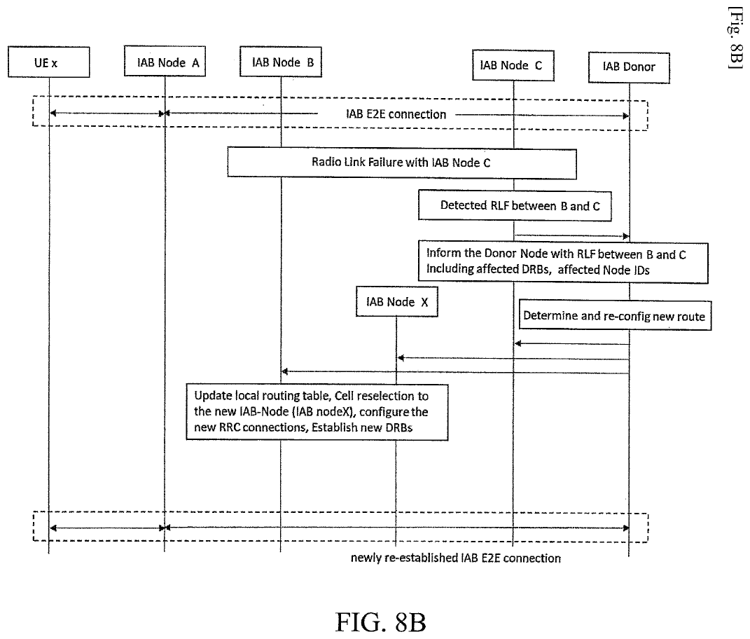

FIGS. 8A and 8B depict an example message sequence or flow of information according to the architectures disclosed in FIGS. 3A-3E for IAB-node communication to establish an RRC connection with IAB-donor, including an F1 setup procedure.

FIG. 8A is a diagram of an example flow of information transmit/receive and/or processing by IAB-node(s) and an IAB-donor according to aspects of the present embodiments. In this embodiment, a message sequence is depicted for IAB-node A, IAB-node B, IAB-node X, IAB-node C, and IAB-donor and used to establish an end to end connection between the IABs (IAB E2E connection) including UE x. With further reference to FIG. 8A, a Radio Link Failure may have occurred between IAB-node B and IAB-node C, where IAB-node C has detected such failure (upstream detection). IAB-node C may then inform the donor node (IAB-donor) with RLF between IAB-node B and IAB-node C including the affected DRBs, affected Node IDs (e.g., IAB-node A, IAB-node B, IAB-node X, and IAB-node C). In this embodiment, based on this information being received by the IAB-donor, the IAB-donor may determine and reconfigure a new route. In such embodiment IAB-node B may update the local routing table, cell reselection to the new IAB-node (IAB-node X), configure the new RRC connections, and establish new DRBs. Once the reselection is completed, the newly reestablished IAB E2E connection is formed.

FIG. 8B is a diagram of an example flow of information transmit/receive and/or processing by IAB-node(s) and an IAB-donor according to aspects of the present embodiments and as disclosed in FIG. 8A where in FIG. 8B, the architectures shown in FIGS. 3B, 3D, and 3E is used. In this embodiment, the same a message sequence of FIG. 8A is depicted for IAB-node A, IAB-node B, IAB-node X, IAB-node C, and IAB-donor and used to establish an end to end connection between the IABs (IAB E2E connection) including UE x. With further reference to FIG. 8B, a Radio Link Failure may have occurred between IAB-node B and IAB-node C, where IAB-node C has detected such failure (upstream detection). IAB-node C may then inform the donor node (IAB-donor) with RLF between IAB-node B and IAB-node C including the affected DRBs, affected Node IDs (e.g., IAB-node A, IAB-node B, and IAB-node C). In this embodiment, based on this information being received by the IAB-donor, the IAB-donor may determine and reconfigure a new route. In such embodiment IAB-node B may update the local routing table, cell reselection to the new IAB-node (IAB-node X), configure the new RRC connections, and establish new DRBs. Once the reselection is completed, the newly reestablished IAB E2E connection is formed. The embodiment depicted in this figure provides a scenario where as show in FIGS. 3B, 3D, and 3E, the Protocol Data Unit (PDU) session may be provided through a tunnel between the child IAB-node(s) and the IAB-donor. That is, in a PDU session, since the node (UE or IAB-node) may receive services through a PDU session, a logical connection between the two nodes may be established and an association made via a tunnel, for example, from IAB-node B to IAB-donor.

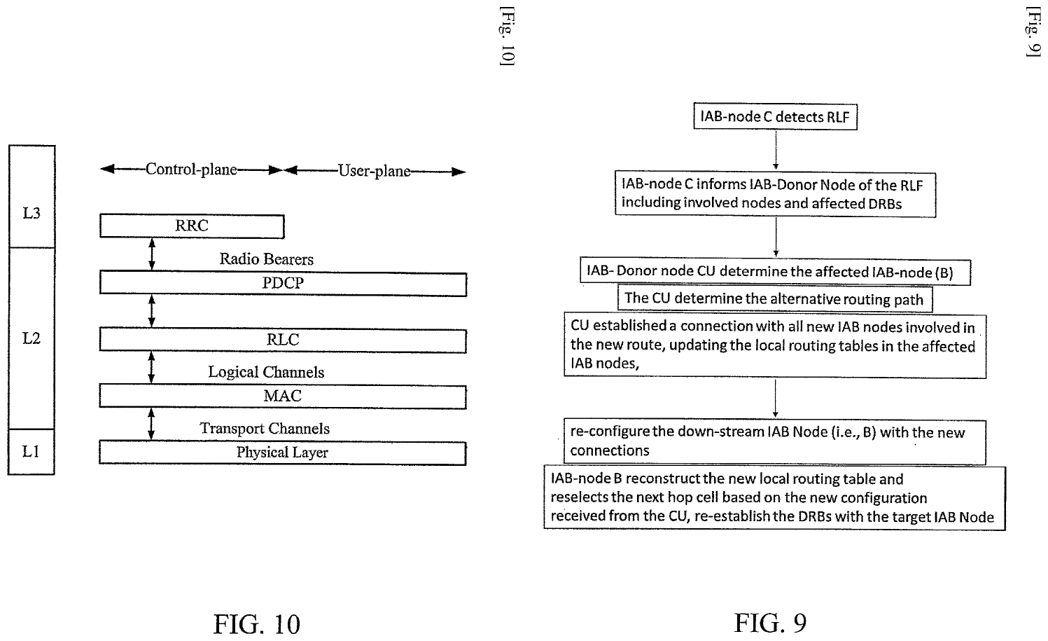

FIG. 9 is a flowchart of an exemplary process method of reestablishing connection with an IAB-donor after a Radio Link Failure (RLF) in a wireless network in which the system comprises the same nodes as depicted in FIGS. 8A-8B. The method depicted in the flowchart includes the steps of: (a) IAB-node C detects RLF with IAB-node B (step 910); (b) IAB-node C informs IAB-donor of the RLF including involved nodes and affected DRBs (step 920); (c) IAB-donor CU may then determine the affected IAB-node(s) (e.g., IAB-node B) (step 930); (d) the CU may determine the alternative routing path based on the received information (step 940); (e) the CU may establish a connection with all new IAB nodes involved in the new route, and updating the local routing tables in the affected IAB-nodes (step 950); (f) reconfigure the downstream IAB-node (e.g., IAB-node B) with the new connections (step 960); and (g) IAB-node B reconstruct the new local routing table and reselects the next hop cell based on the new configuration received from the CU, and re-establish the DRBs with the target IAB-node.

In the present aspects of different embodiments, a set of new and/or existing Information Elements in existing RRC messages (RRC Re-establishment, RRC Resume, RRC Reconfiguration) may be used to provide additional and/or expanded function in order to convey IAB-Node RLF conditions including one or more affected IAB Node ID, affected DRBs, affected Next hop IAB Node ID, or target IAB Donor Node. In one embodiment, the Adaptation layer may extract these IEs for the RRC message and determine the alternative Next Hop IAB or the route toward IAB Donor node CU. Accordingly, the current embodiments may take the RRC signal and add information useful to connectivity and send to the other layers.

Additionally, a set of new and/or existing IEs added to the F-interface messages (e.g., UE Context Setup REQ, GNB-DU Configuration Update, GNB-CU Configuration Update, gNB-DU Resource Coordination REQ, UE Context Setup REQ, GNB-DU Configuration Update ACKNOWLEDGE, Configuration Update GNB-CU Configuration Update ACKNOWLEDGE, gNB-DU Resource Coordination RES, etc. in accordance with 3GPP TS 38.473 V15.2.1 (2018-07)) may be used to identify the IAB RLF condition including downstream IAB Node(s), Upstream IAB Node(s), and/or the IAB Donor Node CU ID. Accordingly, embodiments described herein support downstream RLF detection and re-routing and upstream RLF detection and re-routing, where a cell reselection may include partially established stack and thereby not require establishing the whole stack.

A person skilled in the art would appreciate that a protocol stack refers to a group of protocols that are running concurrently, employed for the implementation of interconnectivity rules. Thereby, the embodiments disclosed herein allow a layered approach to establishing or reestablishing a connection between an IAB-node and an IAB-donor. In one embodiment, based on the lower or lowest protocol on the stack dealing with low-level interaction with the communications hardware and having higher layer protocol stacks adding more features to provide IAB functionality with wireless self-backhauling capabilities, faster cell reselection may be implemented and performed. The capability to perform faster cell reselection is based on the IAB-donor stack having been already established and measured as being faster in comparison to the processors having to perform cell reselection to include all the different protocol stacks. The capability to allow for partially establishing the stack according to the present embodiments, provides systems, devices, and methods for establishing the lower stack when a link failure is detected and allow it to communicate with the upper stack which has previously been established. That is, since the donor portion of the protocol stack is already established, and the portion that is lost is the one associated with the IAB-node having the RLF, then the lower stack portion belonging to the IAB-node may be established and used with the previously established upper stack protocol of the IAB-donor eliminating the need to perform a cell reselecting and establish the entirety of the protocol stack.

FIG. 10 is a diagram illustrating an example of a radio protocol architecture for the control and user planes in a mobile communications network. The radio protocol architecture for the UE and/or the gNodeB may be shown with three layers: Layer 1, Layer 2, and Layer 3. Layer 1 (L1 layer) is the lowest layer and implements various physical layer signal processing functions. Layer 2 (L2 layer) is above the physical layer and responsible for the link between the UE and/or gNodeB over the physical layer. In the user plane, the L2 layer may include a media access control (MAC) sublayer, a radio link control (RLC) sublayer, and a packet data convergence protocol (PDCP) sublayer, which are terminated at the gNodeB on the network side. Although not shown, the UE may have several upper layers above the L2 layer including a network layer (e.g., IP layer) that is terminated at the PDN gateway on the network side, and an application layer that is terminated at the other end of the connection (e.g., far end UE, server, etc.). The control plane also includes a radio resource control (RRC) sublayer in Layer 3 (L3 layer). The RRC sublayer is responsible for obtaining radio resources (i.e., radio bearers) and for configuring the lower layers using RRC signaling between the IAB-nodes and/or the UE and an IAB-donor.

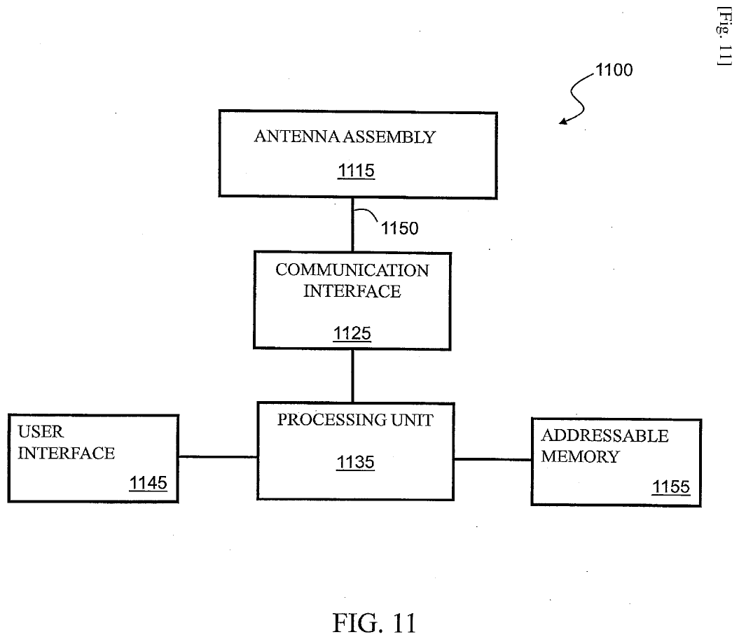

FIG. 11 illustrates an embodiment of a UE and/or base station comprising components of a computing device 1100 according to the present embodiments. The device 1100 illustrated may comprise an antenna assembly 1115, a communication interface 1125, a processing unit 1135, a user interface 1145, and an addressable memory 1155. In some embodiments, the antenna assembly 1115 may be in direct physical communication 1150 with the communication interface 1125. The addressable memory 1155 may include a random access memory (RAM) or another type of dynamic storage device, a read only memory (ROM) or another type of static storage device, a removable memory card, and/or another type of memory to store data and instructions that may be used by the processing unit 1135. The user interface 1145 may provide a user the ability to input information to the device 1100 and/or receive output information from the device 1100. The communication interface 1125 may include a transceiver that enables mobile communication device to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. The communication interface 1125 may include a transmitter that converts baseband signals to radio frequency (RF) signals and/or a receiver that converts RF signals to baseband signals. The communication interface 1125 may also be coupled (not shown) to antenna assembly 1115 for transmitting and receiving RF signals. Additionally, the antenna assembly 1115 may include one or more antennas to transmit and/or receive RF signals. The antenna assembly 1115 may, for example, receive RF signals from the communication interface and transmit the signals and provide them to the communication interface.

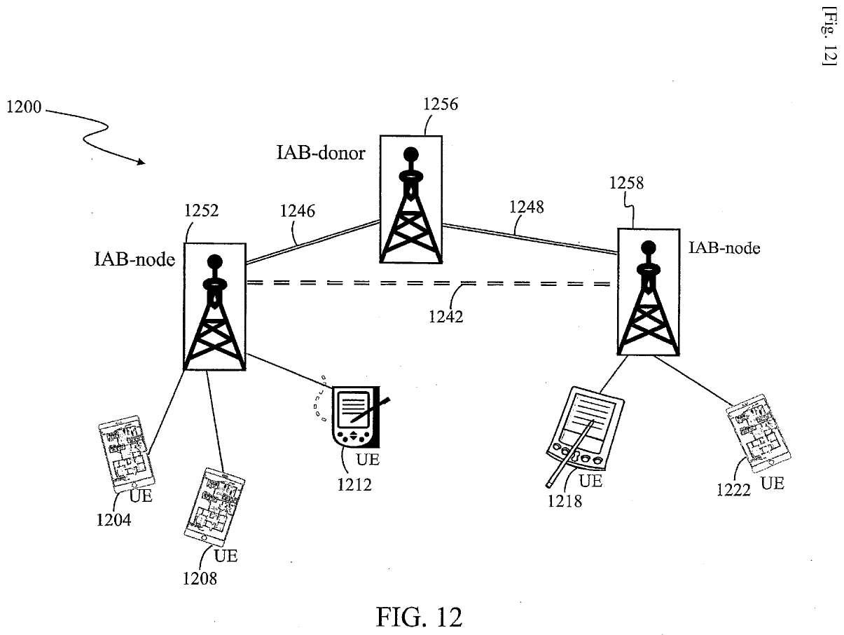

FIG. 12 depicts an example of a mobile network infrastructure 1200 where a number of UEs and IAB-nodes, comprising components of a computing device as illustrated in FIG. 11, are illustrated in communication with each other. In one embodiment, a plurality of UEs 1204, 1208, 1212, 1218, 1222 are connected to a set of IAB-nodes 1252, 1258 and the IAB-nodes 1252, 1258 may optionally be in communication with each other 1242, and/or an IAB-donor 1256 using the different aspects of the present embodiments. That is, the IAB-nodes 1252, 1258 may send out discovery information to other devices on the network (e.g., the Cell ID and resource configuration of the transmitting nodes are sent to the receiving node) and also provide MT functionality in connecting to the IAB-donor 1256. The examples of UEs may also be receiving discovery information and if not barred, then requesting connections and to use resources by transmitting connection requests to the IAB-nodes and/or IAB-donors. In one embodiment, an IAB-donor 1256 may limit or bar any requests from UEs for connection due to them being already connected to other IAB-nodes and committed resources to the backhaul traffic. In another embodiment, the IAB-donor 1256 may accept the UE's connection request but prioritize the IAB-node backhaul traffic over any connections used by the UE's. In yet another embodiment, the IAB-donor 1256 and/or IAB-nodes 1252, 1258 may detect and communicate RLFs according to the aspects of the current embodiments, which may then be propagated down between IAB-nodes and UEs, where the child nodes (e.g., IAB-node or UE in the network) may detect upstream connection failures.

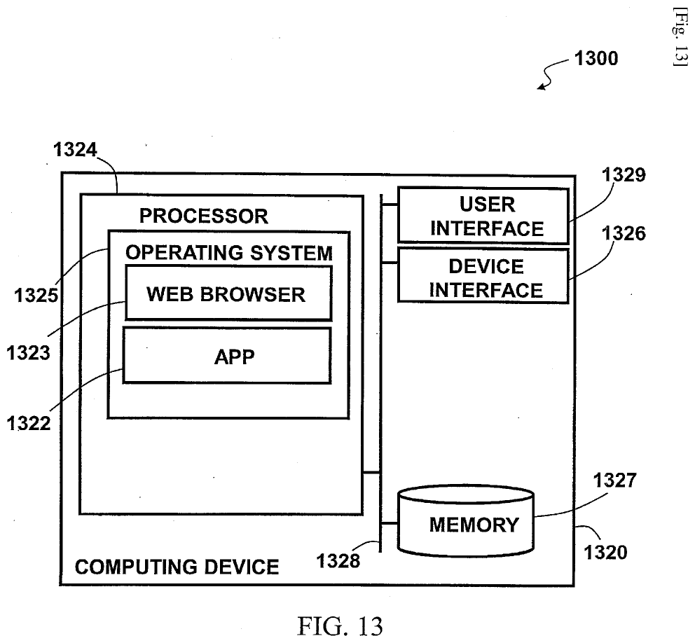

FIG. 13 illustrates an example of a top level functional block diagram of a computing device embodiment 1300. The example operating environment is shown as a computing device 1320 comprising a processor 1324, such as a central processing unit (CPU), addressable memory 1327, an external device interface 1326, e.g., an optional universal serial bus port and related processing, and/or an Ethernet port and related processing, and an optional user interface 1329, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 1328. In some embodiments, via an operating system 1325 such as one supporting a web browser 1323 and applications 1322, the processor 1324 may be configured to execute steps of a process establishing a communication channel and processing according to the embodiments described above.

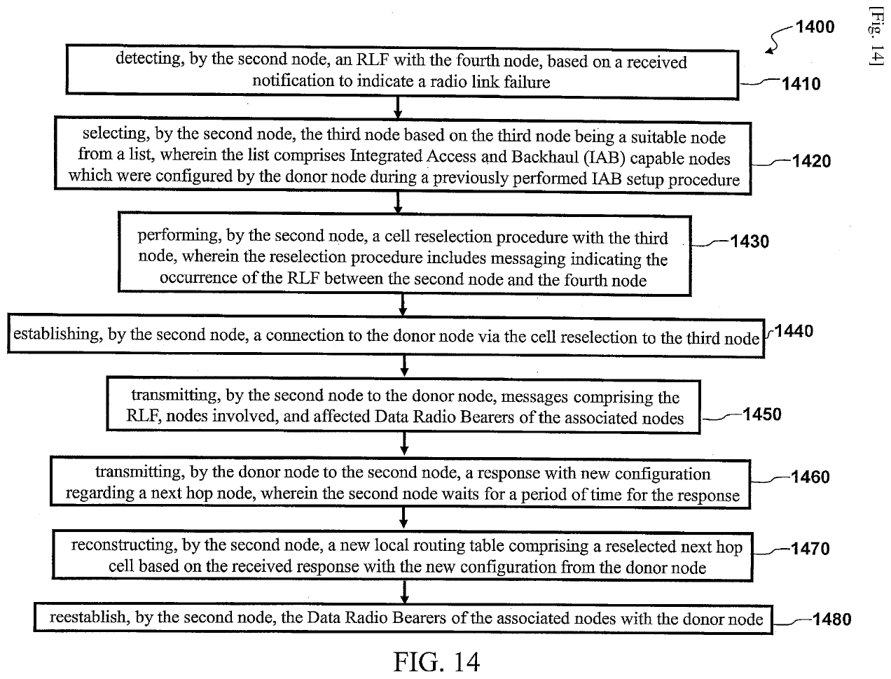

FIG. 14 is a flowchart of an exemplary process 1400 method of establishing new end to end connection based on Radio Link Failures (RLF) in a Wireless Relay Network in which the system comprises a computer and/or computing circuitry that may be configured to execute the steps as depicted. Additionally, the wireless relay network may have a donor node, a first node, a second node, a third node, and a fourth node, where the donor node may be an Integrated Access and Backhaul (IAB) node connected to a core network, and where the first node, the second node, the third node, and the fourth node each may have Mobile Termination (MT) functionality capabilities. The method depicted in the flowchart includes the steps of: (a) detecting, by the second node, an RLF with the fourth node, based on a received notification to indicate a radio link failure (step 1410); (b) selecting, by the second node, the third node based on the third node being a suitable node from a list, wherein the list comprises Integrated Access and Backhaul (IAB) capable nodes which were configured by the donor node during a previously performed IAB setup procedure (step 1420); (c) performing, by the second node, a cell reselection procedure with the third node, wherein the reselection procedure includes messaging indicating the occurrence of the RLF between the second node and the fourth node (step 1430); (d) establishing, by the second node, a connection to the donor node via the cell reselection to the third node (step 1440); (e) transmitting, by the second node to the donor node, messages comprising the RLF, nodes involved, and affected Data Radio Bearers of the associated nodes (step 1450); (f) transmitting, by the donor node to the second node, a response with new configuration regarding a next hop node, wherein the second node waits for a period of time for the response (step 1460); (g) reconstructing, by the second node, a new local routing table comprising a reselected next hop cell based on the received response with the new configuration from the donor node (step 1470); and (h) reestablish, by the second node, the Data Radio Bearers of the associated nodes with the donor node (step 1480).

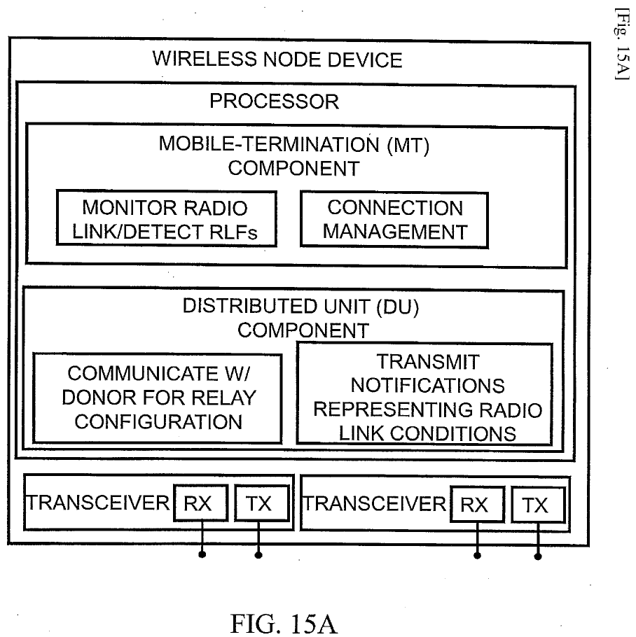

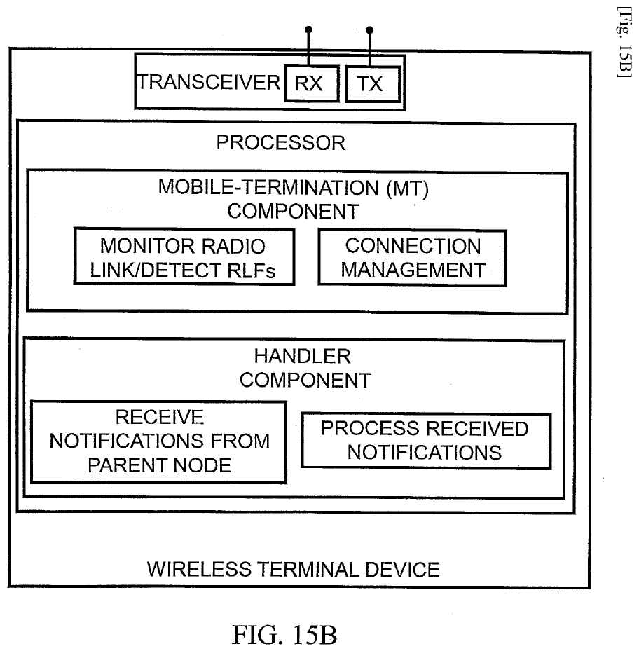

FIG. 15A is a functional block diagram of a wireless node device which may be a parent IAB-node that may be in communication with an IAB-donor upstream and a UE and/or child IAB-node downstream. In some embodiment, the parent IAB-node may itself be connected to another IAB-node upstream and accordingly, part of an end to end connection between a set of IAB-nodes and an IAB-donor. The set of IAB-nodes may include a processor and two transceivers, where each transceiver may have a transmitter component and a receiver component, and in some embodiments, one transceiver may be used for connection to and communications with upstream devices (upstream radio links) and the other used for connection to and communications with downstream devices (downstream radio links). That is, in one embodiment, one transceiver may be dedicated to communicating with IAB-donors/parent IAB-nodes (via a Mobile-Termination (MT) Component) and the other transceiver with child IAB-nodes and/or UEs (via a Distributed Unit (DU) Component). The mobile-termination component may provide a function that terminates the radio interface layers, similar to a UE but implemented on the IAB-nodes as disclosed herein. The example wireless node device depicted in FIG. 15A may further include a processor which may comprise the Mobile-Termination (MT) Component and the Distributed Unit (DU) Component. In this embodiment, the MT component may be configured to monitor the radio link and detect radio link conditions on the upstream radio links, such as Radio Link Failures (RLFs). The MT component may also include a connection management that may provide, for example, cell selection, connection establishment and reestablishment functionality. The DU component may be configured to communicate with the IAB-donor for relay configuration. The DU component may also be configured to process the detected radio link conditions and transmit notifications representing the radio link conditions to the downstream nodes.

FIG. 15B is a functional block diagram of a wireless terminal device which may be a UE and/or child IAB-node in communication with an IAB-donor or a parent IAB-node upstream (itself in communication with an IAB-donor). The wireless terminal device may include a transceiver having a transmitter and receiver for communicating with other IAB-donors/nodes upstream. The example wireless node device depicted in FIG. 15B may further include a processor which may comprise the Mobile-Termination (MT) Component and Handler Component. In this embodiment, the MT component may be configured to monitor the radio link and detect any Radio Link Failures (RLFs). The MT component may also include a connection management that may provide, for example, cell selection, connection establishment and reestablishment functionality. The handler component may be configured to receive notifications from a parent node, for example, an IAB-donor or parent IAB-node upstream, the notifications representing radio conditions of the parent node's upstream radio links. The handler component may also be configured to process the received notifications from upstream nodes according to the aspects of the different embodiments. Upon processing of the notifications, the handler component may instruct the connection management to perform designated actions (e.g., cell selection).

The abovementioned features may be applicable to 3rd Generation Partnership

Project; Technical Specification Group Radio Access Network; Study on Integrated Access and Backhaul; (Release 15) for 3GPP TR 38.874 V0.3.2 (2018-06) and applicable standards.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed con currently. Likewise, steps that have been presented as being performed concurrently may in alternative embodiments be performed separately.

1. A method of reestablishing a connection based on a Radio Link Failure (RLF) in a Wireless Relay Network using alternative routes, the wireless relay network having a donor node, a first node (IAB-node A), a second node (IAB-node B), a third node (IAB-node X), and a fourth node (IAB-node C), wherein the donor node is an Integrated Access and Backhaul (IAB) node connected to a core network, and wherein the first node, the second node, the third node, and the fourth node each have Mobile Termination (MT) functionality capabilities, the method comprising:
detecting, by the second node, an RLF with the fourth node, based on a received notification to indicate a radio link failure;
selecting, by the second node, the third node based on the third node being a suitable node from a list, wherein the list comprises Integrated Access and Backhaul (IAB) capable nodes which were configured by the donor node during a previously performed IAB setup procedure;
performing, by the second node, a cell reselection procedure with the third node, wherein the reselection procedure includes messaging indicating the occurrence of the RLF between the second node and the fourth node;
establishing, by the second node, a connection to the donor node via the cell reselection to the third node;
transmitting, by the second node to the donor node, messages comprising the RLF, nodes involved, and affected Data Radio Bearers of the associated nodes;
transmitting, by the donor node to the second node, a response with new configuration regarding a next hop node, wherein the second node waits for a period of time for the response;
reconstructing, by the second node, a new local routing table comprising a reselected next hop cell based on the received response with the new configuration from the donor node; and
reestablishing, by the second node, the Data Radio Bearers of the associated nodes with the donor node.

2. The method of claim 1, wherein the radio link failure is based on signal strength of at least one of: Reference Signal Received Power (RSRP)/Reference Signal Received Quality (RSRQ) levels associated with the connection.

3. The method of claim 1, wherein the donor node comprises a Control Unit, the Control Unit provides functionality of at least one of: an interface to the core network, Control Plane, and User Plane.

4. The method of claim 3, wherein the Control Unit is configured to manage at least one of:
a distributed unit residing on the donor node; and
any remote distributed units residing on other IAB-nodes.

5. The method of claim 1, wherein the second node is in connected mode with the fourth node.

6. The method of claim 1, wherein the first node, the second node, the third node, and the fourth node each comprise a Distributed Unit component and a Mobile Termination component.

7. The method of claim 1, wherein the RLF notification is carried by at least one of: an Adaptation Layer, a Radio Link Control (RLC) sublayer, a Medium Access Control (MAC) sublayer, and a physical layer signaling.

8. The method of claim 1, further comprising:
transmitting, by the donor node, commands to all surrounding nodes to establish a new route.

9. A wireless node equipped with at least two radio interfaces comprising a first interface and a second interface, the first interface being configured to establish a first radio link with at least one parent node, the second interface being configured to establish a second radio link(s) with one or more wireless terminals, the wireless node having a processor circuitry and addressable memory, the processor configured to:
detect a Radio Link Failure (RLF) with another node based on a received notification to indicate a radio link failure (dep: connected mode);
select a new node to establish a radio link with based on the new node being a suitable node from a list, wherein the list comprises Integrated Access and Backhaul (IAB) capable nodes which were configured by a donor node during a previously performed IAB setup procedure;
perform a cell reselection procedure with the new node, wherein the reselection procedure includes messaging indicating the occurrence of the RLF;
establish a connection to the donor node via the cell reselection to the new node;
transmit messages to the donor node, the messages comprising the RLF, nodes involved, and affected Data Radio Bearers of the associated nodes;
wait to receive from the donor node a response with new configuration regarding a next hop node;
reconstruct a new local routing table comprising a reselected next hop cell based on the received response with the new configuration from the donor node; and
reestablish the Data Radio Bearers of the associated nodes with the donor node.

10. The wireless node of claim 9, wherein the radio link failure is based on signal strength of at least one of: Reference Signal Received Power (RSRP)/Reference Signal Received Quality (RSRQ) levels associated with the connection.

11. The wireless node of claim 9, wherein the donor node comprises a Control Unit, the Control Unit provides functionality of at least one of:
an interface to the core network, Control Plane, and User Plane.

12. The wireless node of claim 11, wherein the Control Unit is configured to manage at least one of:
a distributed unit residing on the donor node; and
any remote distributed units residing on other IAB-nodes.

13. The wireless node of claim 9, wherein the wireless node is in connected mode with the another node.

14. The wireless node of claim 9, wherein the wireless node, the another node, and the new node each comprise a Distributed Unit component and a Mobile Termination component.

15. The wireless node of claim 9, wherein the RLF notification is carried by at least one of: an Adaptation Layer, a Radio Link Control (RLC) sublayer, a Medium Access Control (MAC) sublayer, and a physical layer signaling.

16. The wireless node of claim 9, wherein the processor is further configured to:
receive transmitted commands by the donor node, sent to all surrounding nodes to establish a new route.

17. The wireless node of claim 9, wherein the wireless node comprises:
a receiver circuitry configured to receive, for the first interface, downlink (DL) user data and/or DL signaling data;
a transmitter circuitry configured to transmit, for the first interface, uplink (UL) user data and/or UL signaling data;
a receiver circuitry configured to receive, for the second interface, UL user data and/or UL signaling data;
transmitter circuitry configured to transmit, for the second interface, DL user data and/or DL signaling data.
